(19) United States
(12) Patent Application Publication
(10) Pub. No.: US 2025/0131799 A1
(43) Pub. Date: Apr. 24, 2025

(54) MULTI HAND POKER GAME

(71) Applicant: Kenneth Joseph Brunelle, Las Vegas, NV (US)

(72) Inventor: Kenneth Joseph Brunelle, Las Vegas, NV (US)

(21) Appl. No.: 18/492,262

(22) Filed: Oct. 23, 2023

(51) Int. Cl. G07F 17/32

(52) U.S. Cl. CPC G07F 17/3293; G07F 17/3211

(57) ABSTRACT

A video poker game for play by a player utilizes an array of cards including a plurality of components including rows, columns, diagonals. Each of the components having more than two cards define one of a plurality of poker hands. The components include a varying number of cards, such that the plurality of poker hands includes a three-card hand, four-card hand, five-card hand. Preferably, the array includes fifteen cards, and configured to define three three-card hands, three four-card hands, three five-card hands. The game preferably includes a wager placed by the player, a set of winning three-card poker hands, set of winning four-card poker hands and set of winning five-card poker hands. The player receives a payout based on the wager for each poker hand which forms a winning poker hand based on the sets of winning hands.

### FIELD OF THE INVENTION

This invention relates to games of chance, and more specifically to a multi-hand poker game using hands having a varying number of cards.

### BACKGROUND OF THE INVENTION

Games based upon variations of poker have become very popular as casino-type wagering games. The success of poker-type games in the gaming industry is, in part, based on the game's simplicity. Poker-type games on gaming machines have become increasingly popular in recent years. One of those poker-type games is video poker. Video poker is a popular electronic card game based on five-card draw poker. The goal of the game is to assemble the strongest possible poker combination. While traditional five-card poker games are a mainstay, poker games utilizing varying-length hands have seen increased play, including three-card and four-card poker games. The present invention attempts to capitalize on the popularity of poker-type games by offering a multi-hand poker game incorporating hands of differing lengths.

### SUMMARY OF THE INVENTION

The present invention provides a game for play by a player using a plurality of cards. An array of cards includes a plurality of components, with the components including rows, columns, and diagonals. The array of cards defines a first hand having x cards, and a second hand having y cards. Each of the first and second hands includes all of the cards of one of the plurality of components. The first and second hands are preferably poker hands. The game may further include a wager placed by the player, and first and second sets of winning combinations, with the first set of winning combinations being for hands having x cards, and the second set of winning combinations being for hands having y cards. In this embodiment, the player receives a payout based on the wager if the first hand includes one of the first set of winning combinations, and/or if the second hand includes one of the second set of winning combinations. Preferably, the payout increases as the odds of forming a given winning combination decrease. The game is preferably played using a video display.

In one aspect of the present invention, x=3 and y=4, such that the first hand is a three-card hand and the second hand is a four-card hand. The game may further include a third hand having z cards, with the third hand similarly including all the cards in one of the plurality of components. In this embodiment, the game may further include a third set of winning combinations for hands having z cards, with the player also receiving a payout if the third hand includes one of the third set of winning combinations. Preferably, z=5, such that the third hand is a five-card hand. The array of cards may be configured such that each of the plurality of components defines a hand, with the array of cards defining exactly three of the first hand, exactly three of the second hand, and exactly three of the third hand (i.e., exactly three hands having x cards, exactly three hands having y cards, and exactly three hands having z cards).

The present invention also provides a video poker game for play by a player. The game comprises an array of cards including a plurality of components, with the plurality of components including rows, columns, and diagonals. Each of the components having more than two cards therein defines one of a plurality of poker hands. The components include a varying number of cards, such that the plurality of poker hands include at least one three-card poker hand, at least one four-card poker hand, and at least one five-card poker hand. Preferably, the array of cards includes fifteen cards, with the array of cards being configured to define exactly three three-card poker hands, exactly three four-card poker hands, and exactly three five-card poker hands. The video poker game may further include a wager placed by the player, a set of winning three-card poker hands, a set of winning four-card poker hands, and a set of winning five-card poker hands. In this embodiment, the player receives a payout based on the wager for each of the plurality of poker hands forming a winning poker hand based on the sets of winning poker hands.

The present invention further provides a method of playing a poker game. First, a wager is wagered by a player. Next, an array of cards is distributed to the player. The array includes a plurality of horizontal, vertical, and diagonal components, with each of the components having more than two cards defining one of a plurality of hands. The plurality of hands includes at least one three-card hand, at least one four-card hand, and at least one five-card hand. Each of the plurality of hands is then evaluated based on the odds of achieving a given poker hand of identical length. Winning hands, if any, are then determined from among the plurality of hands, with the player being awarded a payout based on the wager for the winning hands. The plurality of hands may include three three-card hands, three four-card hands, and three five-card hands. The array of cards may include exactly fifteen cards. The game is preferably played using a video display.

### BRIEF DESCRIPTION OF THE DRAWING

The above features and advantages and other features and advantages of the present invention are readily apparent from the following detailed description of the best modes for carrying out the invention when taken in connection with the accompanying drawings, wherein:

FIG. 1 is a schematic of an array of cards displayed in columns and rows usable to play a game according to the present invention; and

FIG. 2 is a schematic of an array of cards displaying the winning possibilities arranged in columns, rows and diagonally, usable to play a game according to the present invention; and

FIG. 3 is an electronic gaming machine utilizing the array of cards usable to play a game according to the present invention; and

FIG. 4 is a flowchart presenting a method of playing a game according to the present invention; and

FIG. 5 shows a payout chart including multiple payouts for 3-card poker hands; and

FIG. 6 shows a payout chart including multiple payouts for 4-card poker Hands; and

FIG. 7 shows a payout chart including multiple payouts for 4-card poker hands.

### DESCRIPTION OF THE PREFERRED EMBODIMENTS

The present invention provides a multi-hand card game utilizing at least two hands of varying length. Preferably, the game is played using a standard deck of fifty-two cards, with each of the cards having a card value associated therewith. Each card represents a number between 1 and 11: i.e., cards with numbers on them have the numeric value shown, jacks, queens and kings have a numeric value of 10, and aces have a numeric value of 1 or 11. It should be appreciated that while the preferred embodiment of the present invention utilizes this traditional notion of card values, the game may be played using other symbolic representations without changing the inventive concept.

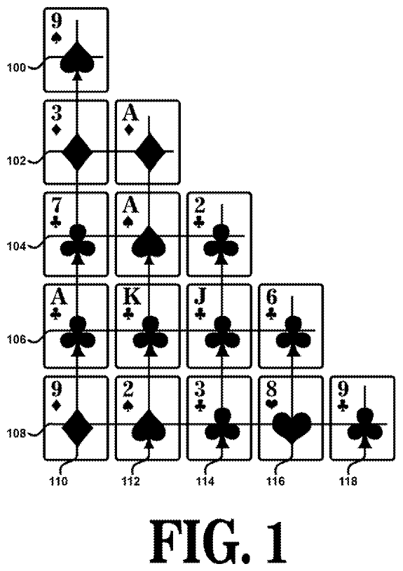

A plurality of cards is presented to a player in the form of an array, with the array defining a plurality of hands as described herein. The preferred embodiment of an array of cards for use with the present invention is shown as FIG. 1. It can be seen that the array includes a plurality of components, namely rows, diagonals, and columns. The array has been labeled for ease of description, with rows being labeled 1 through 5, and columns being labeled A though E. It should be noted that the rows and columns, and henceforth the diagonals, are of varying length. In FIG. 1, row 1 (100) includes the 9 of spades, row 2 (102) includes the 3 of diamonds and the A of diamonds, row 3 (104) includes the 7 of clubs, A of spades and 2 of clubs, row 4 (106) includes the A of clubs, K of clubs, J of clubs and the 6 of clubs and row 5 (108) includes the 9 of diamonds, 2 of spades, 3 of clubs, 8 of hearts and the 9 of clubs. In FIG. 1, column A (110) includes 9 of diamonds, A of clubs, 7 of clubs, 3 of diamonds and 9 of spades, column B (112) includes the 2 of spades, K of clubs, A of spades and A of diamonds, column C (114) includes the 3 of clubs, J of clubs and 2 of clubs, column D (116) includes the 8 of hearts and 6 of clubs and column E (118) includes the 9 of clubs.

According to the invention, the plurality of hands is defined by the array. Particularly, each hand includes all the cards of one of the components. By way of example, cards 4A, 4B, 4C and 4D could be a four-card hand, with that particular four-card hand being all the cards of the component labeled as row 4. Similarly, cards 1A, 2A, 3A, 4A and 5A could be a five-card hand, with that five-card hand being all the cards of the component labeled as column A. Note also that diagonal components may also define hands, i.e., cards 3A, 4B and 5C could be a three-card hand, with the three-card hand being all the cards in the diagonal component running from card 3A through card 5C.

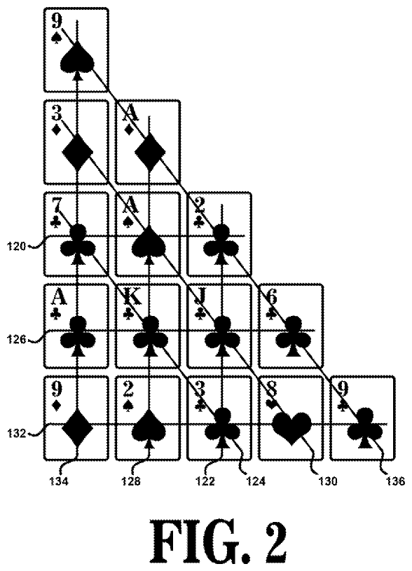

In the preferred embodiment, each component of the array having more than two cards (i.e., three or more cards) defines a hand, such that nine total hands are formed as shown in FIG. 2. Particularly, the array in FIG. 2 forms three three-card hands (120, 122, 124), three four-card hands (126, 128, 130), and three five-card hands (132, 134, 136). When referring to FIG. 1, the three 3-card hands, three 4-card hands, and three 5-card hands are also visible in the rows and columns diagram as follows:
3-card hands: 3A, 3B, 3C
   3C, 4C, 5C
   3A, 4B, 5C
Four-card hands: 4A, 4B, 4C, 4D
   2B, 3B, 4B, 5B
   2A, 3B, 4C, 5D
Five-card hands: 1A, 2A, 3A, 4A, 5A
   5A, 5B, 5C, 5D, 5E
   1A, 2B, 3C, 4D, 5E
      Note that the preferred embodiment of the array includes exactly three components of each hand length—one row, one column and one diagonal.

The present invention is described herein as a poker-type game, with hands being scored based using poker-type rankings. However, the game may be played using an alternative scoring system without changing the inventive concept. Additionally, the game is preferably played as a video-poker type game for case and speed of array distribution. However, the game could be played in a live setting using tangible cards without changing the inventive concept. To practice the present invention, it matters only that an array of cards having a plurality of horizontal, vertical, and diagonal components define a plurality of varying-length hands, with each hand including all cards of one of the components.

Following distribution of the array, each hand is scored using poker-type rankings. Preferably, a set of winning combinations is defined for hands of each length. For example, in the preferred embodiment, wherein the array defines hands having three, four and five cards, three sets of winning combinations would be necessary. Examples of winning combinations are provided below. In the preferred embodiment, a player places a wager prior to distribution of the array. The player receives a payout based on the wager if any of the plurality of hands includes any of the winning combinations defined for that length of hand.

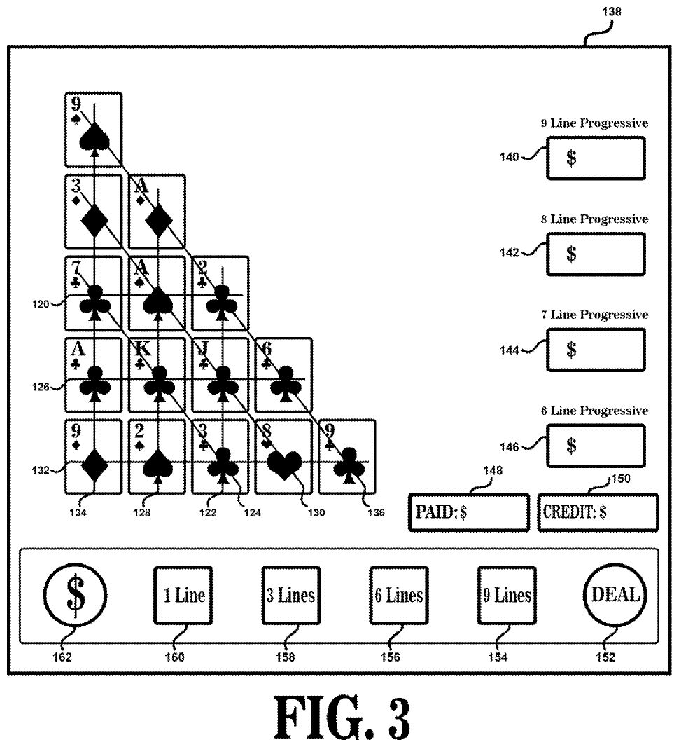

Turning to FIG. 3, a typical electronic video gaming machine 138 that is configured to provide to the player the method of the present invention. An array of cards, as depicted in FIG. 1 and FIG. 2, is displayed on the video screen portion of a gaming machine. The gaming machine also depicts a “BET” button ($) 162, a “DEAL” button 152, multiple payline buttons, including a 1-line button 160, a 3-line button 158, a 6-line button 156 and a 9-line button 154. After the player makes an initial bet, they will the choose the number of lines they wish to play. Each line represents a poker hand, including 3-card hands, 4-card hands, and 5-card hands. The player must bet at least one line to be eligible to play the game. The gaming machine also depicts a “PAID” meter 148, a “CREDIT meter 150, and four progressive jackpot meters, 140, 142, 144 and 146. Depending on variations of the present invention, the progressive jackpots could be represented by a royal flush or a four of a kind. In another version of the present invention, no progressive jackpots would be offered to the player. The progressive jackpot awards do not change the inventive concept but would add more excitement to the game for the player.

While winning combinations may vary within the scope of the preferred embodiment, various winning combinations, with examples of each included parenthetically, are provided herein by way of example. Winning combinations for three-card hands may include a pair (9 spades, 9 clubs), a three-card straight (6 hearts, 7 clubs, 8 spades), a three-card flush (2 diamonds, 7 diamonds, K diamonds), three-of-a-kind (5 clubs, 5 hearts, 5 spades) and a straight flush (9 clubs, 10 clubs, J clubs). Winning combinations for four-card hands may include a pair (A diamonds, A spades), two pair (9 clubs, 9 hearts, 10 clubs, 10 diamonds), a four-card straight (3 hearts, 4 diamonds, 5 hearts, 6 spades), a four-card flush (2 hearts, 5 hearts, 6 hearts, A hearts), three-of-a-kind (Q clubs, Q diamonds, Q spades), a straight flush (7 clubs, 8 clubs, 9 clubs, 10 clubs), four-of-a-kind (K clubs, K diamonds, K hearts, K spades). Winning combinations for five-card hands may include a pair (4 clubs, 4 spades), two pair (5 hearts, 5 spades, J clubs, J diamonds), three-of-a-kind (3 clubs, 3 diamonds, 3 hearts), a five-card straight (3 hearts, 4 diamonds, 5 diamonds, 6 clubs, 7 spades), a five-card flush (3 hearts, 5 hearts, 8 hearts, 9 hearts, K hearts), a full house (10 clubs, 10 diamonds, Q clubs, Q diamonds, Q spades), four-of-a-kind (5 clubs, 5 diamonds, 5 hearts, 5 spades), a straight flush (5 spades, 6 spades, 7 spades, 8 spades, 9 spades) and a royal flush (10 diamonds, J diamonds, Q diamonds, K diamonds, A diamonds).

Preferably, the payout increases as the odds of forming a given winning combination decreases. For example, the odds of hitting a royal flush are much lower than the odds of hitting a straight. Therefore, the payout for a royal flush would likely be substantially higher than the payout for a straight. Additionally, with nine hands defined by the array in the preferred embodiment, a bonus may be awarded if a player achieves a predetermined number of winning hands. For example, assume four of the three-card hands, two of the four-card hands, and two of the five-card hands are winning hands. The player may then receive a bonus award for achieving eight total winning hands, regardless of the rank of each winning hand.

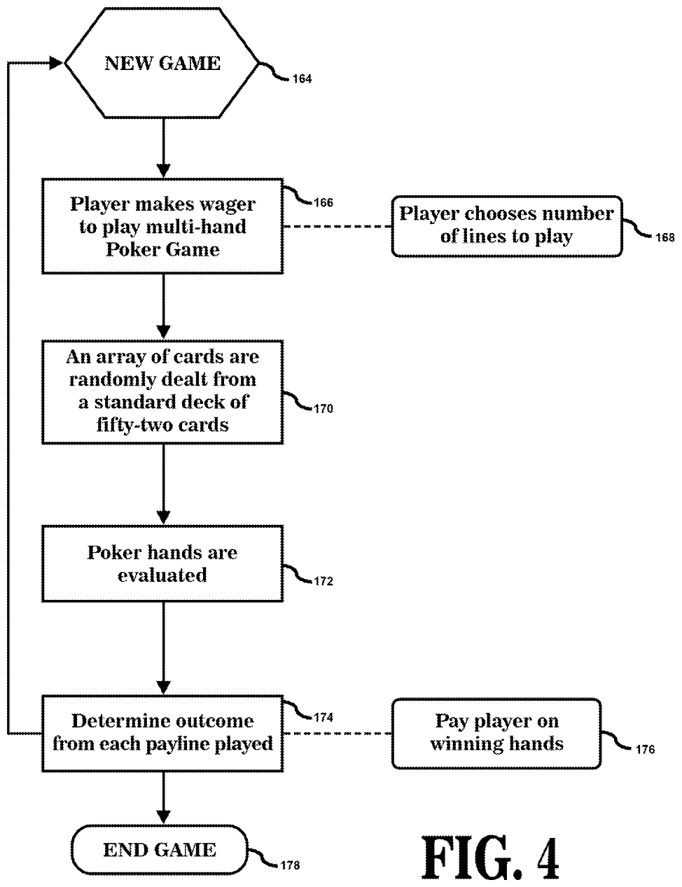

FIG. 4, illustrates a flowchart detailing the method of play according to the present invention. A typical electronic gaming machine is provided to the player. The player initiates the start of a new game 164. A wager is placed by a player, as described in box 166. Next, the player choses the number of lines 168 they wish to play. An array of cards are displayed to the player on the electronic gaming machine's video screen 170. The array of cards includes a plurality of horizontal, vertical, and diagonal components, with each component having more than two cards defining one of a plurality of hands. The plurality of hands includes at least one three-card hand, at least one four-card hand, and at least one five-card hand. Each hand is then evaluated based on the odds of achieving a given poker hand of identical length 172. Based on the evaluation, the winning hands, if any, are determined from among the plurality of hands 174. A payout is awarded based on the wager for the winning hands 176. Preferably, the plurality of hands includes three three-card hands, three four-card hands, and three five-card hands. Finally, the player may end the game or repeat the process 178. The game is best suited for play using a video display, but can be played using a tangible display without changing the inventive concept. In the preferred embodiment, the array includes fifteen cards.

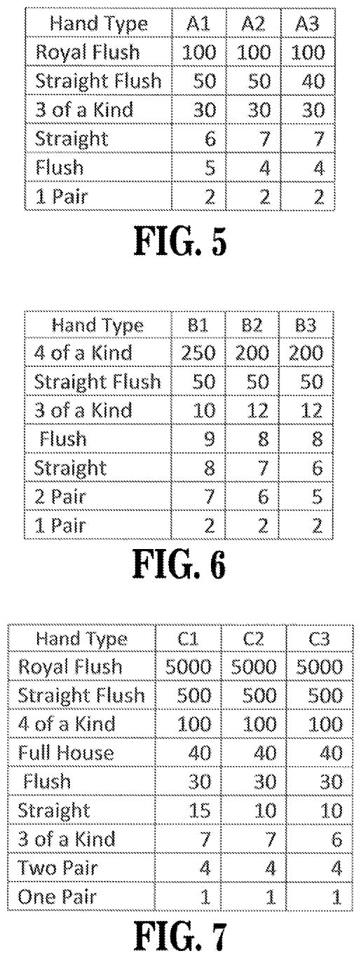

Turning to FIG. 5, FIG. 6, and FIG. 7. In the present invention there are multiple 3-card hands, 4-card hands, and 5-card hands. FIG. 5 represents three separate payouts (A1, A2, and A3) for any player receiving any pair, a flush, a straight, a 3 of a kind, a straight flush, or a royal flush. All payouts pertaining to the 3-card hands are “for 1” on a per coin/credit basis. FIG. 6 represents three separate payouts (B1, B2, and B3) for any player receiving any pair, any two pair, a straight, a flush, a 3 of a kind, a straight flush, or a 4 of a kind. All payouts pertaining to the 4-card hands are “for 1” on a per coin/credit basis. FIG. 6 represents three separate payouts (C1, C2, and C3) for any player receiving any pair, any two pair, a 3 of a kind, a straight, a flush, a full house, a 4of a kind, a straight flush, or a royal flush. All payouts pertaining to the 5-card hands are “for 1” on a per coin/credit basis.

While the best modes for carrying out the invention have been described in detail, it is to be understood that the terminology used is intended to be in the nature of words and description rather than of limitation. Those familiar with the art to which this invention relates will recognize that many modifications of the present invention are possible considering the above teachings. It is, therefore, to be understood that within the scope of the appended claims, the invention may be practiced in a substantially equivalent way other than as specifically described herein. For example, a player may be allowed to draw cards on at least one line consisting of a 3-card hand, a 4-card hand, or a 5-card hand.

1. A game for play by a player using a plurality of cards comprising:
an array of cards including a plurality of components, said plurality of components including rows, columns and diagonals;
a first hand having x cards, said first hand being defined by said array of cards; and
a second hand having y cards, said second hand being defined by said array of cards:
wherein each of said first and second hands includes all cards of one of said plurality of components.

2. The game of claim 1, wherein said first and second hands are poker hands.

3. The game of claim 1, further including:
a wager placed by said player;
a first set of winning combinations for hands having x cards; and
a second set of winning combinations for hands having y cards;
wherein said player receives a payout based on said wager if one of said first hand includes one of said first set of winning combinations and said second hand includes one of said second set of winning combinations.

4. The game of claim3, wherein said payout increases as the odds of forming a given winning combination decrease.

5. The game of claim 1, wherein x=3 and y=4, such that said first hand is a three-card hand and said second hand is a four-card hand.

6. The game of claim 1, further including a third hand having z cards, said third hand including all cards of one of said plurality of components.

7. The game of claim 6, further including:
a wager placed by said player;
a first set of winning combinations for hands having x cards;
a second set of winning combinations for hands having y cards; and
a third set of winning combinations for hands having z cards;
wherein said player receives a payout based on said wager if one of said first hand includes one of said first set of winning combinations, said second hand includes one of said second set of winning combinations, and said third hand includes once of said third set of winning combinations.

8. The game of claim 7, wherein said payout increases as the odds of forming a given winning combination decrease.

9. The game of claim 6, wherein each of said plurality of components defines hand.

10. The game of claim 6, wherein z=5, such that said third hand is a five-card a hand, said array of cards configured to define exactly three of said first hand, exactly three of said second hand, and exactly three of said third band.

11. The game of claim 1, wherein said game is played using a video display.

12. A video poker game for play by a player, said game comprising:
an array of cards including a plurality of components, said plurality of components including rows, columns and diagonals;
a plurality of poker hands, with each of said plurality of components having more than two cards therein defining one of said plurality of poker hands; wherein said components include a varying number of cards, such that said plurality of poker hands include at least one three-card poker hand, at least one four-card poker hand, and at least one five-card poker hand.

13. The video poker game of claim 12, wherein said array of cards includes fifteen cards, and wherein said array of cards is configured to define exactly three three-card poker hands, exactly three four-card poker hands, and exactly three five-card poker hands.

14. The video poker game of claim 12, further including:
a wager placed by said player;
a set of winning three-card poker hands;
a set of winning four-card poker hands; and
a set of winning five-card poker hands;
said player receiving a payout based on said wager for each of said plurality of poker hands forming a winning poker hand.

15. The video poker game of claim 14, wherein said player receives a bonus based on said wager for achieving a predetermined number of winning poker hands.

16. A method of playing a poker game comprising:
wagering of a wager by a player;
distributing an array of cards to said player, said array including a plurality of horizontal, vertical, and diagonal components, wherein each of said plurality of components having more than two cards defines one of a plurality of hands, said plurality of hands including at least one three-card hand, at least one four-card hand, and at least one five-card hand:
evaluating said plurality of hands based on the odds of achieving a given poker hand of identical length;
determining winning hands, if any, from among said plurality of hands; and awarding a payout based on said wager for said winning hands.

17. The method of claim 16, wherein said plurality of hands include three three-card hands, three four-card hands, and three five-card hands.

18. The method of claim 16, wherein said game is played using a video display.

19. The method of claim 16, wherein said array of cards includes fifteen cards.
